(19) United States
(12) Patent Application Publication
(10) Pub. No.: US 2021/0314958 A1
(43) Pub. Date: Oct. 7, 2021

(54) METHOD AND APPARATUS FOR MINIMIZING INTERFERENCE CAUSED BY HAPS THAT PROVIDE COMMUNICATIONS SERVICES

(71) Applicant: Loon LLC, Mountain View, CA (US)

(72) Inventors: Alfred Cohen, Sunnyvale, CA (US); Sharath Ananth, Cupertino, CA (US); Nidhi Gulia, Cupertino, CA (US); Dino Radakovic, San Jose, CA (US)

(21) Appl. No.: 16/838,053

(22) Filed: Apr. 2, 2020

(51) Int. Cl. H04W 72/08; H04L 27/26; H04L 5/00; H04W 76/11

(52) U.S. Cl. CPC H04W 72/082; H04L 27/2675; H04W 76/11; H04L 5/0048; H04L 27/2657

(57) ABSTRACT

A method and an apparatus are provided for minimizing interference caused by a plurality of high-altitude platforms (HAPs) configured for operation in the stratosphere. At least one receiver in a node receives information including a plurality of parameters associated with the HAPs and areas on the ground to which HAPs provide communication services. At least one processor analyzes the information to determine at least one of time symbol offsets and physical cell identifies (PCIs) for each of the HAPs to provide the communication services with minimal interference. At least one transmitter transmits command signals including setting instructions with regard to at least one of time symbol offsets and PCIs the HAPs should use to minimize interference while providing communication services.

### BACKGROUND

Telecommunications connectivity via the Internet, cellular data networks and other systems is available in many parts of the world. However, there are many locations where such connectivity is unavailable, unreliable or subject to outages from natural disasters. Some systems are able to provide network access to remote locations or to locations with limited networking infrastructure via satellites or other high-altitude platforms (HAPs) that are located in the stratosphere. HAPs may communicate with each other and with ground-based networking equipment and mobile devices to provide telecommunications connectivity, for instance according to the Long-Term Evolution (LTE) standard.

A Physical Cell Identifier (PCID) is an identifier of a cell in a physical layer of an LTE network, which is used to differentiate between different transmitters. In order for cells to communicate in a collision-free environment, there should not be any two neighboring cells operating at the same frequency that share the same PCID. For example, if a user equipment (UE) is to be handed over from one cell to another, and the source cell and the target cell are sharing the same PCID, collision and confusion may occur because there would be no unambiguous way to notify the UE to which cell it should be handed over. The UE could interpret a command as if it should stay connected to a service call. This would eventually lead to a service interruption for the UE, as it would lose the connection with the source cell while entering the target cell.

### BRIEF SUMMARY

Aspects of the technology provide systems and methods for avoiding collisions through the use of PCI planning. A beam footprint of a High-Altitude Platform (HAP) (e.g., a satellite, an unmanned aerial vehicle (UAV), or a balloon) is the ground area that its transponders offer coverage. When a four sector system with overlapping beam footprints is used, Physical Cell Identity (PCI) planning is required because when two cells having the same mod 3 PCID, downlink (DL) reference symbols overlap. In addition, when PCI mod 30 has the same value in two cells, then uplink (UL) reference signals are in conflict. Further, when PCI mod 50 has the same value in two cells, collisions between Physical Control Format Indicator Channels (PCFICH) or between Random Access Channels (RACHs) or between Physical Random Access Channels (PRACHs) can occur. Collisions between Primary Synchronization Signal (PSS)/Secondary Synchronization Signal (SSS)/Master Information Block (MIB) signals or between Cell-Specific Reference Signals (CRSs) can also occur.

In one aspect, a node is configured to minimize interference caused by a plurality of HAPs configured for operation in the stratosphere. The node may comprise at least one transmitter configured to transmit command signals; at least one receiver configured to receive information including a plurality of parameters associated with the HAPs and areas on the ground to which the HAPs provide communication services; a memory configured to store the information received by the at least one receiver, and at least one processor coupled to the at least one transmitter, the at least one receiver and the memory. The at least one processor is configured to analyze the received information to determine at least one of time symbol offsets and PCIs for each of the HAPs to provide the communication services with minimal interference. The transmit command signals include setting instructions with regard to at least one of time symbol offsets and selected PCIs the HAPs should use to minimize interference while providing communication services.

The setting instructions in the command signals may provide information to the HAPs to avoid pilot symbol collisions by changing timing between cell sectors. The HAPs may shift pilot symbols in a time domain to avoid the pilot symbol collisions. The pilot symbols may be shifted by 1 pilot symbol. The pilot symbols may be shifted by 2 pilot symbols. The command signals may be based, in part, on an analysis of population densities performed by the at least one processor. The command signals may be further based on a location of each of the HAPs. The command signals may be further based on distances of the HAP locations from the population densities. The setting instructions may be implemented by the HAPs to most aggressively reduce interference in one or more regions with the largest population densities. The setting instructions may specify selected differences between PCIs to reduce or eliminate interference, wherein the selected differences are associated with a frequency offset, a timing offset, or a combination thereof.

In another aspect, a method is provided for minimizing interference caused by a plurality of HAPs configured for operation in the stratosphere. The method comprises receiving, by at least one receiver, information including a plurality of parameters associated with the HAPs and areas on the ground to which HAPs provide communication services; storing, by a memory, the information received by the at least one receiver; analyzing, by at least one processor, the information to determine at least one of time symbol offsets and PCIs for each of the HAPs to provide the communication services with minimal interference; and transmitting, by the at least one transmitter, command signals including setting instructions with regard to at least one of time symbol offsets and selected PCIs the HAPs should use to minimize interference while providing communication services.

### BRIEF DESCRIPTION OF THE DRAWINGS

FIG. 1 is a functional diagram of an example network in accordance with aspects of the technology.

FIG. 2 illustrates a balloon configuration in accordance with aspects of the technology.

FIG. 3 is an example payload arrangement in accordance with aspects of the technology.

FIG. 4 is an example of a balloon platform with lateral propulsion in accordance with aspects of the technology.

FIG. 5 illustrates a two-pilot case where DL pilots 1 are generated by a first cell and DL pilots 2 are generated by a second cell.

FIG. 6 shows that when PCI-mod1 is 1, then the pilots 0 move up on the frequency axis.

FIG. 7 shows that when PCI-mod1 is 2, then the pilots 0 move up again on the frequency axis.

FIG. 8 shows that when PCI-mod1 is 3, then the pilots 0 move up again on the frequency axis causing collisions between the pilots 0 and the pilots 1.

FIG. 9 shows collisions between pilot symbols can be avoided by changing timing between sectors, which intentionally causes pilots to be misaligned between the different cell sectors.

FIG. 10 shows that when PCI-mod3 is 0, the pilots 0 can be shifted by 1 symbol so that the time offsets are 1, 5, 8 and 12 on the x-axis instead of 0, 4, 7 and 11.

FIG. 11 shows that when PCI-mod3 is 0, the pilots 0 can be shifted by 2 symbols so that the time offsets are 2, 6, 9 and 13 on the x-axis instead of 0, 4, 7 and 11.

FIG. 12 shows that when PCI-mod3 is 3, the pilots 0 can be shifted by 1 symbol so that the time offsets are 1, 5, 8 and 12 on the x-axis instead of 0, 4, 7 and 11.

FIG. 13 shows that when PCI-mod3 is 3, the pilots 0 can be shifted by 2 symbols so that the time symbol offsets are 2, 6, 9 and 13 on the x-axis instead of 0, 4, 7 and 11.

FIGS. 14-16 illustrate various example of two HAPs communicating with a UE located in a densely populated region on the ground.

FIG. 17 illustrates a time offset controller in accordance with aspects of the technology.

FIG. 18 shows a flow diagram of a method in accordance with aspects of the technology.

### DETAILED DESCRIPTION

### Example Networks

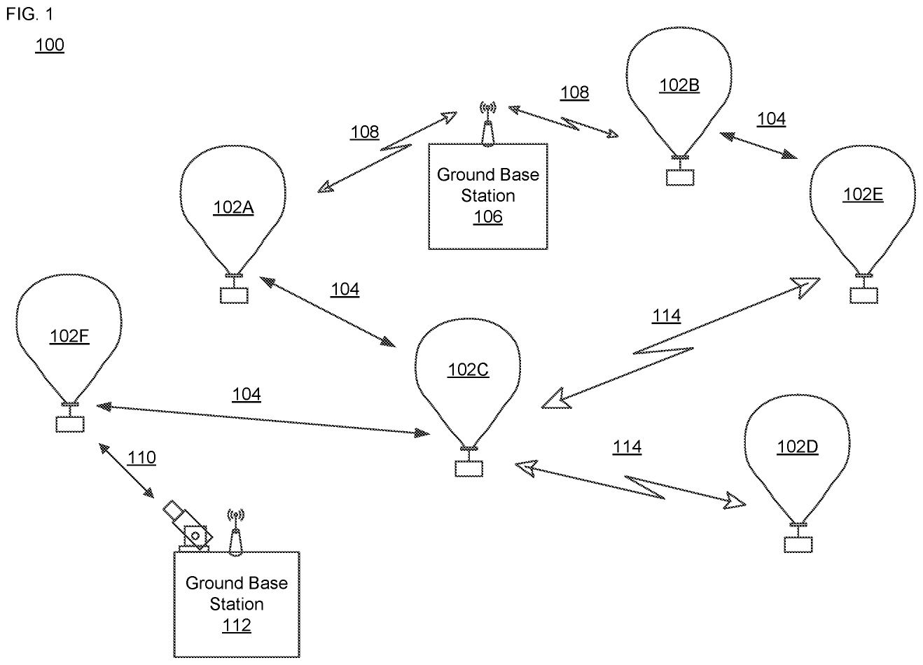

FIG. 1 depicts an example network 100 in which a fleet of balloon or other high-altitude platforms described above may be used. This example should not be considered as limiting the scope of the disclosure or usefulness of the features described herein. The network 100 may be considered a balloon network. In this example, the network 100 includes a plurality of devices, such as balloons 102A-F as well as ground-base stations 106 and 112. The network 100 may also include a plurality of additional devices, such as various devices supporting a telecommunication service (not shown) as discussed in more detail below or other systems that may participate in the network.

The devices in the network 100 are configured to communicate with one another. As an example, the balloons may include communication links 104 and/or 114 in order to facilitate intra-balloon communications. By way of example, links 114 may employ radio frequency (RF) signals (e.g., millimeter wave transmissions) while links 104 employ free-space optical transmission. Alternatively, all links may be RF, optical, or a hybrid that employs both RF and optical transmission. In this way balloons 102A-F may collectively function as a mesh network for data communications. At least some of the balloons may be configured for communications with ground-based stations 106 and 112 via respective links 108 and 110, which may be RF and/or optical links.

In one scenario, a given balloon 102 may be configured to transmit an optical signal via an optical link 104. Here, the given balloon 102 may use one or more high-power light-emitting diodes (LEDs) to transmit an optical signal. Alternatively, some or all of the balloons 102 may include laser systems for free-space optical communications over the optical links 104. Other types of free-space communication are possible. Further, in order to receive an optical signal from another balloon via an optical link 104, the balloon may include one or more optical receivers.

The balloons may also utilize one or more of various RF air-interface protocols for communication with ground-based stations via respective communication links. For instance, some or all of balloons 102A-F may be configured to communicate with ground-based stations 106 and 112 via RF links 108 using various protocols described in IEEE 802.11 (including any of the IEEE 802.11 revisions), cellular protocols such as GSM, CDMA, UMTS, EV-DO, WiMAX, and/or LTE, 5G and/or one or more proprietary protocols developed for long distance communication, among other possibilities. In one example using LTE communication, the base stations may be Evolved Node B (eNB) base stations. In another example, they may be base transceiver station (BTS) base stations. These examples are not limiting.

In some examples, the links may not provide a desired link capacity for HAP-to-ground communications. For instance, increased capacity may be desirable to provide backhaul links from a ground-based gateway. Accordingly, an example network may also include balloons, which could provide a high-capacity air-ground link between the various balloons of the network and the ground base stations. For example, in network 100, balloon 102F may be configured to directly communicate with station 112.

Like other balloons in the network 100, the balloon 102F may be operable for communication (e.g., RF or optical) with one or more other balloons via link(s) 104. Balloon 102F may also be configured for free-space optical communication with ground-based station 112 via an optical link 110. Optical link 110 may therefore serve as a high-capacity link (as compared to an RF link 108) between the network 100 and the ground-based station 112. Balloon 102F may additionally be operable for RF communication with ground-based stations 106. In other cases, balloon 102F may only use an optical link for balloon-to-ground communications.

Some or all of balloons 102A-F could be equipped with a specialized, high bandwidth RF communication system for balloon-to-ground communications, instead of, or in addition to, a free-space optical communication system. The high bandwidth RF communication system may take the form of an ultra-wideband system, which may provide an RF link with substantially the same capacity as one of the optical links 104.

In a further example, some or all of balloons 102A-F could be configured to establish a communication link with space-based satellites and/or other types of HAPs (e.g., drones, airplanes, airships, etc.) in addition to, or as an alternative to, a ground based communication link. In some embodiments, a balloon may communicate with a satellite or a high-altitude platform via an optical or RF link. However, other types of communication arrangements are possible.

As noted above, the balloons 102A-F may collectively function as a mesh network. More specifically, since balloons 102A-F may communicate with one another using free-space optical links or RF links, the balloons may collectively function as a free-space optical or RF mesh network. In a mesh-network configuration, each balloon may function as a node of the mesh network, which is operable to receive data directed to it and to route data to other balloons. As such, data may be routed from a source balloon to a destination balloon by determining an appropriate sequence of links between the source balloon and the destination balloon.

The network topology may change as the balloons move relative to one another and/or relative to the ground. Accordingly, the network 100 may apply a mesh protocol to update the state of the network as the topology of the network changes. The network 100 may also implement station-keeping functions using winds and altitude control or lateral propulsion to help provide a desired network topology. For example, station-keeping may involve some or all of balloons 102A-F maintaining and/or moving into a certain position relative to one or more other balloons in the network (and possibly in a certain position relative to a ground-based station or service area). As part of this process, each balloon may implement station-keeping functions to determine its desired positioning within the desired topology, and if necessary, to determine how to move to and/or maintain the desired position. For instance, the balloons may move in response to riding a wind current, or may move in a circular or other pattern as they station keep over a region of interest.

The desired topology may vary depending upon the particular implementation and whether or not the balloons are continuously moving. In some cases, balloons may implement station-keeping to provide a substantially uniform topology where the balloons function to position themselves at substantially the same distance (or within a certain range of distances) from adjacent balloons in the network 100. Alternatively, the network 100 may have a non-uniform topology where balloons are distributed more or less densely in certain areas, for various reasons. As an example, to help meet the higher bandwidth demands, balloons may be clustered more densely over areas with greater demand (such as urban areas) and less densely over areas with lesser demand (such as over large bodies of water). In addition, the topology of an example balloon network may be adaptable allowing balloons to adjust their respective positioning in accordance with a change in the desired topology of the network.

### Example High-Altitude Platforms

The balloons of FIG. 1 may be high-altitude balloons or other types of HAPs that are deployed in the stratosphere. As an example, in a high-altitude balloon network, the balloons may generally be configured to operate at stratospheric altitudes, e.g., between 50,000 ft and 70,000 ft or more or less, in order to limit the balloons' exposure to high winds and interference with commercial airplane flights. In order for the balloons to provide a reliable mesh network in the stratosphere, where winds may affect the locations of the various balloons in an asymmetrical manner, the balloons may be configured to move latitudinally and/or longitudinally relative to one another by adjusting their respective altitudes, such that the wind carries the respective balloons to the respectively desired locations. Lateral propulsion may also be employed to affect the balloon's path of travel.

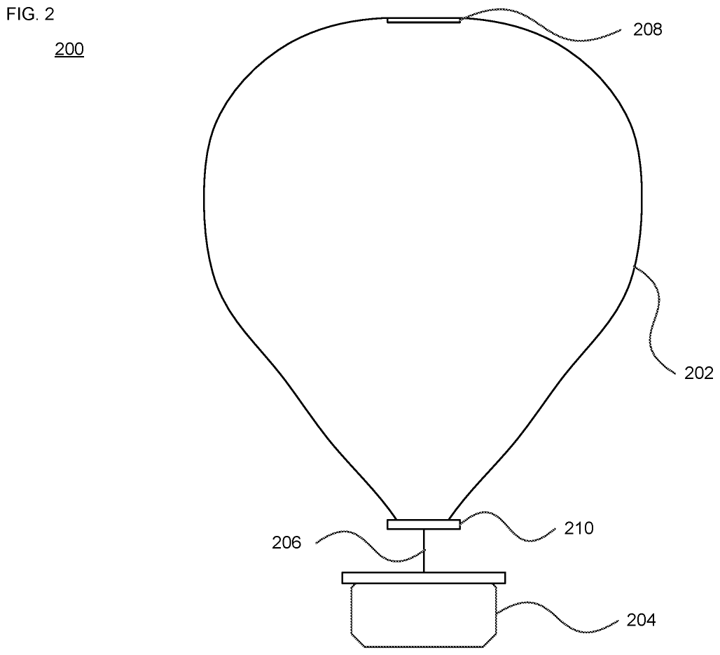

In an example configuration, the high-altitude balloon platforms include an envelope and a payload, along with various other components. FIG. 2 is one example of a high-altitude balloon 200, which may represent any of the balloons of FIG. 1. As shown, the example balloon 200 includes an envelope 202, a payload 204 and a coupling member (e.g., a down connect) 206 therebetween. At least one gore panel forms the envelope, which is configured to maintain pressurized lifting gas therein. For instance, the balloon may be a superpressure balloon. A top plate 208 may be disposed along an upper section of the envelope, while a base plate 210 may be disposed along a lower section of the envelope opposite the top place. In this example, the coupling member 206 connects the payload 204 with the base plate 210.

The envelope 202 may take various shapes and forms. For instance, the envelope 202 may be made of materials such as polyethylene, mylar, FEP, rubber, latex or other thin film materials or composite laminates of those materials with fiber reinforcements imbedded inside or outside. Other materials or combinations thereof or laminations may also be employed to deliver required strength, gas barrier, RF and thermal properties. Furthermore, the shape and size of the envelope 202 may vary depending upon the particular implementation. Additionally, the envelope 202 may be filled with different types of gases, such as air, helium and/or hydrogen. Other types of gases, and combinations thereof, are possible as well. Shapes may include typical balloon shapes like spheres and “pumpkins”, or aerodynamic shapes that are symmetric, provide shaped lift, or are changeable in shape. Lift may come from lift gasses (e.g., helium, hydrogen), electrostatic charging of conductive surfaces, aerodynamic lift (wing shapes), air moving devices (propellers, flapping wings, electrostatic propulsion, etc.) or any hybrid combination of lifting techniques.

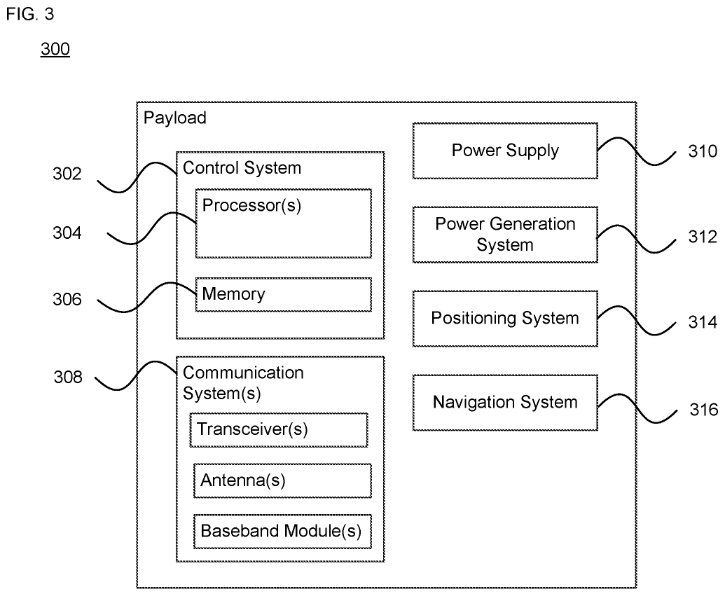

According to one example shown in FIG. 3, a payload 300 of a balloon platform includes a control system 302 having one or more processors 304 and on-board data storage in the form of memory 306. Memory 306 stores information accessible by the processor(s) 304, including instructions that can be executed by the processors. The memory 306 also includes data that can be retrieved, manipulated or stored by the processor. The memory can be of any non-transitory type capable of storing information accessible by the processor, such as a hard-drive, memory card (e.g., thumb drive or SD card), ROM, RAM, and other types of write-capable, and read-only memories. The instructions can be any set of instructions to be executed directly, such as machine code, or indirectly, such as scripts, by the processor. In that regard, the terms “instructions,” “application,” “steps” and “programs” can be used interchangeably herein. The instructions can be stored in object code format for direct processing by the processor, or in any other computing device language including scripts or collections of independent source code modules that are interpreted on demand or compiled in advance. The data can be retrieved, stored or modified by the one or more processors 304 in accordance with the instructions.

The one or more processors 304 can include any conventional processors, such as a commercially available CPU. Alternatively, each processor can be a dedicated component such as an ASIC, controller, or other hardware-based processor. Although FIG. 3 functionally illustrates the processor(s) 304, memory 306, and other elements of control system 302 as being within the same block, the system can actually comprise multiple processors, computers, computing devices, and/or memories that may or may not be stored within the same physical housing. For example, the memory can be a hard drive or other storage media located in a housing different from that of control system 302. Accordingly, references to a processor, computer, computing device, or memory will be understood to include references to a collection of processors, computers, computing devices, or memories that may or may not operate in parallel.

The payload 300 may also include various other types of equipment and systems to provide a number of different functions. For example, as shown the payload 300 includes one or more communication systems 308, which may transmit signals via RF and/or optical links as discussed above. By way of example only, the communication system 308 may provide LTE or other telecommunications services. The communication system(s) 308 includes communication components such as one or more transmitters and receivers (or transceivers), one or more antennas, and one or more baseband modules. As discussed further below, each antenna may have multiple sectors with different beams providing coverage for a number of ground-based users.

The payload 300 is illustrated as also including a power supply 310 to supply power to the various components of balloon. The power supply 310 could include one or more rechargeable batteries or other energy storage systems like capacitors or regenerative fuel cells. In addition, the balloon 300 may include a power generation system 312 in addition to or as part of the power supply. The power generation system 312 may include solar panels, stored energy (hot air), relative wind power generation, or differential atmospheric charging (not shown), or any combination thereof, and could be used to generate power that charges and/or is distributed by the power supply 310.

The payload 300 may additionally include a positioning system 314. The positioning system 314 could include, for example, a global positioning system (GPS), an inertial navigation system, and/or a star-tracking system. The positioning system 314 may additionally or alternatively include various motion sensors (e.g., accelerometers, magnetometers, gyroscopes, and/or compasses).

Payload 300 may include a navigation system 316 separate from, or partially or fully incorporated into control system 302. The navigation system 316 may implement station-keeping functions to maintain position within and/or move to a position in accordance with a desired topology or other service requirement. In particular, the navigation system 316 may use wind data (e.g., from onboard and/or remote sensors) to determine altitudinal and/or lateral positional adjustments that result in the wind carrying the balloon in a desired direction and/or to a desired location. Lateral positional adjustments may also be handled directly by a lateral positioning system that is separate from the payload. Alternatively, the altitudinal and/or lateral adjustments may be computed by a central control location and transmitted by a ground based, air based, or satellite based system and communicated to the high-altitude balloon. In other embodiments, specific balloons may be configured to compute altitudinal and/or lateral adjustments for other balloons and transmit the adjustment commands to those other balloons.

The navigation system 316 is able to evaluate data obtained from onboard navigation sensors, such as an inertial measurement unit (IMU) and/or differential GPS, received data (e.g., weather information), and/or other sensors such as health and performance sensors (e.g., a force torque sensor) to manage operation of the balloon's systems. When decisions are made to activate the lateral propulsion system, for instance to station keep, the navigation system 316 then leverages received sensor data for position, wind direction, altitude and power availability to properly point the propeller and to provide a specific thrust condition for a specific duration or until a specific condition is reached (e.g., a specific velocity or position is reached, while monitoring and reporting overall system health, temperature, vibration, and other performance parameters).

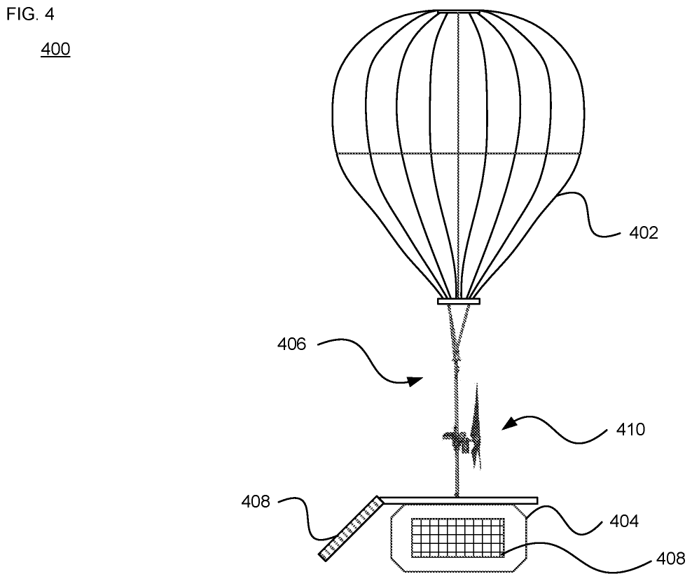

In order to change lateral positions or velocities, the platform may include a lateral propulsion system. FIG. 4 illustrates one example configuration 400 of a balloon platform with propeller-based lateral propulsion, which may represent any of the balloons of FIG. 1. As shown, the example 400 includes an envelope 402, a payload 404 and a down connect member 406 disposed between the envelope 402 and the payload 404. Cables or other wiring between the payload 404 and the envelope 402 may be run within the down connect member 406. One or more solar panel assemblies 408 may be coupled to the payload 404 or another part of the balloon platform. The payload 404 and the solar panel assemblies 408 may be configured to rotate about the down connect member 406 (e.g., up to 3600 rotation), for instance to align the solar panel assemblies 408 with the sun to maximize power generation. Example 400 also illustrates a lateral propulsion system 410. While this example of the lateral propulsion system 410 is one possibility, the location could also be fore and/or aft of the payload section 404, or fore and/or aft of the envelope section 402, or any other location that provides the desired thrust vector.

Other than balloons, drones may fly routes in an autonomous manner, carry cameras for aerial photography, and transport goods from one place to another. The terms “unmanned aerial vehicle (UAV)” and “flying robot” are often used as synonyms for a drone. The spectrum of applications is broad, including aerial monitoring of industrial plants and agriculture fields as well as support for first time responders in case of disasters. For some applications, it is beneficial if a team of drones rather than a single drone is employed. Multiple drones can cover a given area faster or take photos from different perspectives at the same time.

### Example Methods

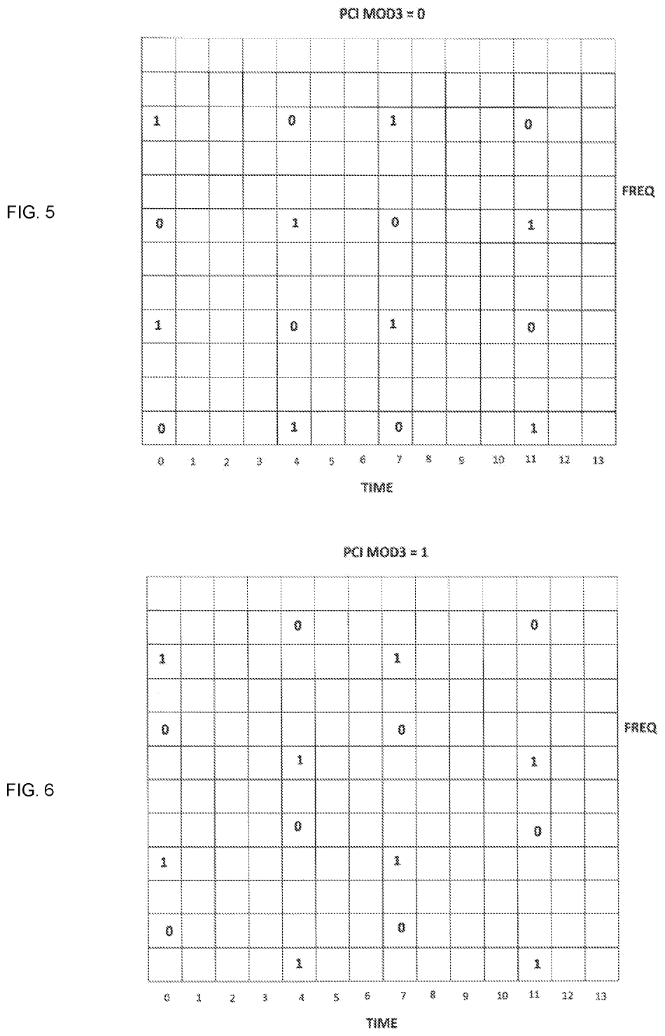

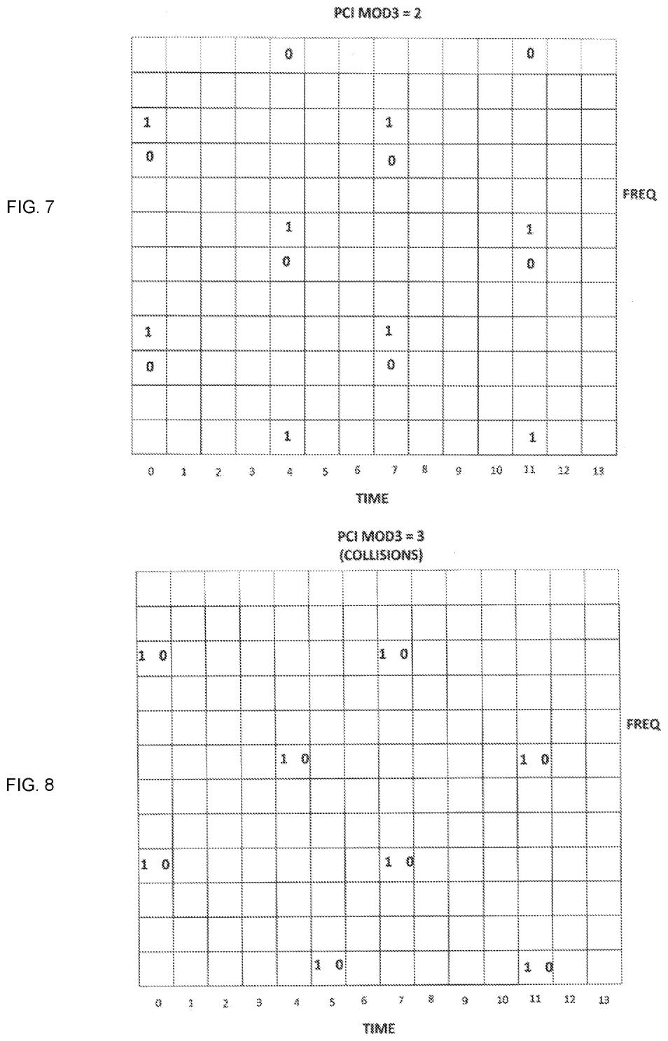

Typically, LTE systems use 2 transmit ports. The 3GPP standard allows for 1 port transmission, 2 port transmission and 4 port transmission. The examples provided by FIGS. 5-8 are related to a 1 antenna port system, also referred to as transmission mode 1 (TM1) in LTE. Similar concepts may be used for 2 port systems such as TM2 and TM4. FIG. 5 illustrates a two-pilot case where DL pilots 1 are generated by a first cell and DL pilots 2 are generated by a second cell. As shown in FIG. 5, the X axis represents a time domain by depicting pilot symbols 0-13, and the Y-axis represents a frequency domain. As shown in FIG. 5, pilots 0 and pilots 1 do not collide when PCI-mod3 is 0. As shown in FIG. 6, when PCI-mod3 is 1, then the pilots 0 move up on the frequency axis. As shown in FIG. 7, when PCI-mod3 is 2, then the pilots 0 move up again on the frequency axis. However, as shown in FIG. 8, when PCI-mod3 is 3, then the pilots 0 move up again on the frequency axis causing collisions between the pilots 0 and the pilots 1. Using frequency offsets, therefore, may produce three non-colliding pilots. However, when a communication system services four sectors, it is inevitable that two sectors have pilots in a same frequency domain, which increases the likelihood of a PCI-mod3 collision.

In other words, when the first cell has a PCI of 0 and the second cell has a PCI of 1, then the first and second cells do not interfere with each other. When the second cell has a PCI of 3, this corresponds to a PCI of 0 because 3 modulo 3 is 0. Thus, the second cell would interfere with the first cell. Accordingly, frequency and timing offsets are combined to reduce or eliminate interference.

When there is a potential for interference to occur between cells, a frequency domain offset or a time domain offset, or a combination thereof, may be used to adjust the frequency domain and/or the time domain.

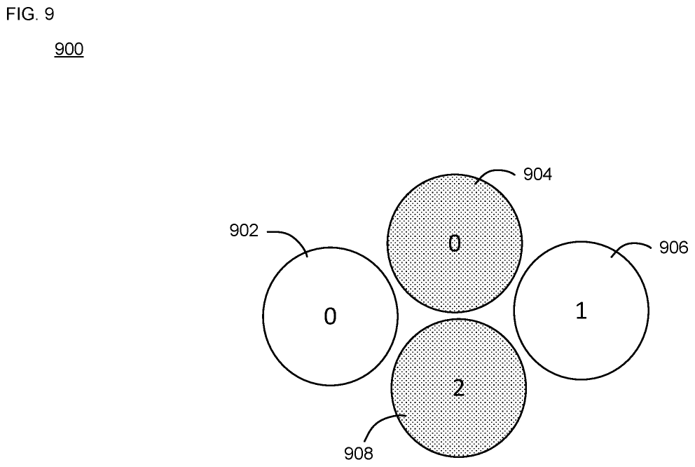

Collisions between pilot symbols can be avoided by changing timing between sectors, which intentionally causes pilots to be misaligned between the different cell sectors. The four sectors 902, 904, 906, 908 shown in FIG. 9 are provided by a communication system of a HAP, such as communication system 308. In this example, 0, 1 and 2 are PCI-mod3 numbers. Sector 902 has PCI mod 0; sector 904 has PCI mod 0; sector 906 has PCI mod 1; and sector 908 has PCI mod 2. Sectors 902 and 904 have the same PCI-mod3 number, and therefore have pilot symbols in the same frequency domain in the absence of any time domain shifts.

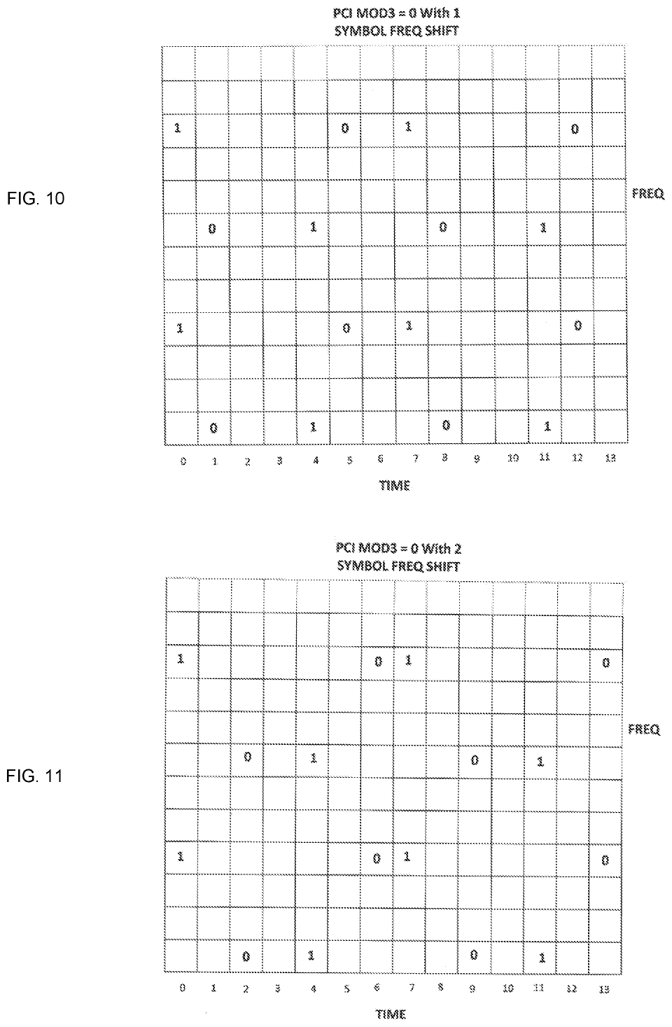

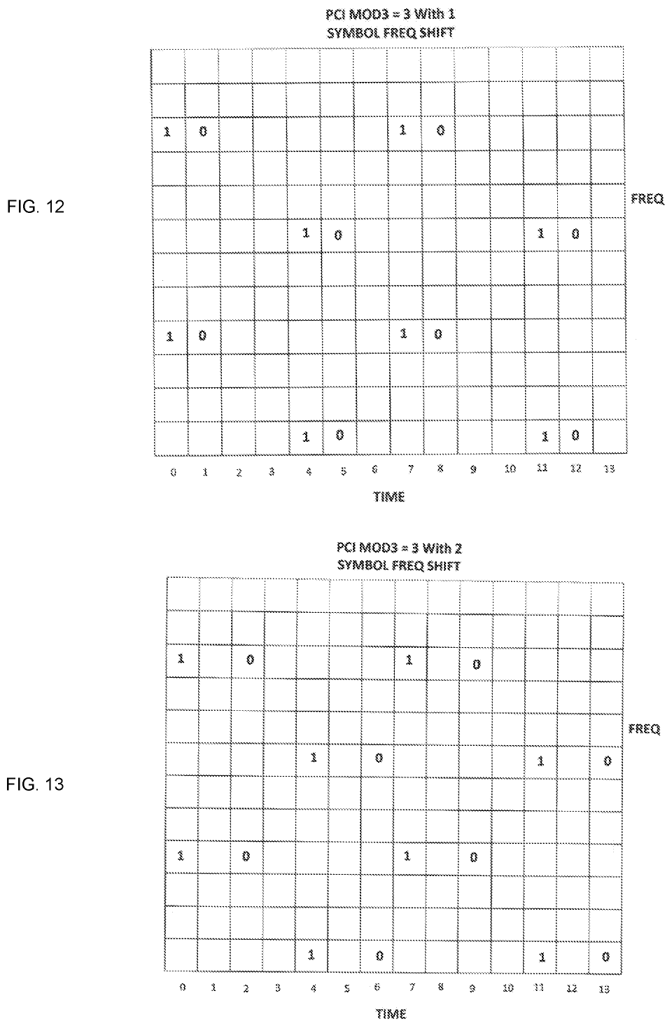

In order to avoid collisions between pilot symbols, the symbols can be shifted in the time domain. For example, FIG. 10 shows that when PCI-mod3 is 0, the pilots 0 can be shifted by 1 symbol so that the time symbol offsets are 1, 5, 8 and 12 on the x-axis instead of 0, 4, 7 and 11. Alternately, for example, FIG. 11 shows that when PCI-mod3 is 0, the pilots 0 can be shifted by 2 symbols so that the time symbol offsets are 2, 6, 9 and 13 on the x-axis instead of 0, 4, 7 and 11. In another example, FIG. 12 shows that when PCI-mod3 is 3, the pilots 0 can be shifted by 1 symbol so that the time symbol offsets are 1, 5, 8 and 12 on the x-axis instead of 0, 4, 7 and 11. Alternately, for example, FIG. 13 shows that when PCI-mod3 is 3, the pilots 0 can be shifted by 2 symbols so that the time symbol offsets are 2, 6, 9 and 13 on the x-axis instead of 0, 4, 7 and 11.

In a mobile environment, adjustments to PCI are necessary as a HAP moves. When dynamically moving, PCI and offset may be determined. Since HAPs are moving all the time, PCI planning needs to be performed on a continuous basis. The PCI planning takes into account: 1) location of population on the ground (actual population density within various sectors), and 2) the location of HAPs and 3) the distances of the HAPs from the population densities. This information may be fed into a processor to estimate the impact of self-interference, which may reflect the interference impact from a single HAP on the ground. The footprint of the overlapping area may be checked to see if it covers a region with a high population density.

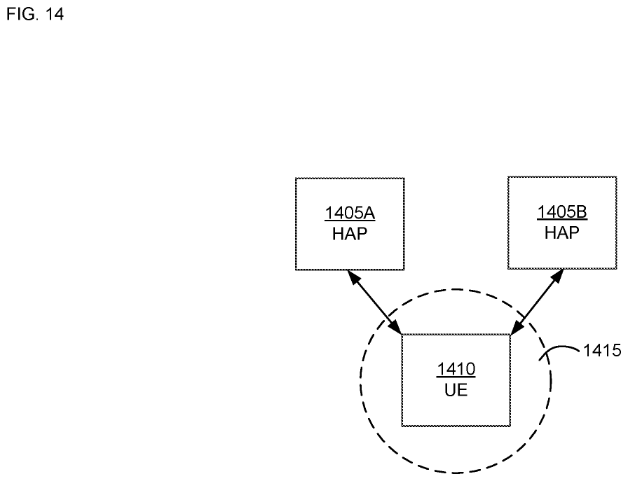

FIG. 14 illustrates two HAPs 1405A and 1405B communicating with a UE 1410A located in a densely populated region 1415 on the ground. The HAPs 1405A and 1405B may be equidistant from the UE 1410. In this situation, the time taken by signals from the HAPs 1405A and 1405B are equal. Thus, any timing difference between the HAPs 1405A and 1405B will apply for UE 1410 using possible timing offsets {1, 2, 5, 6, 8, 9, 12 and 13}.

For example, a time symbol offset of 0 may be applied to HAP 1405A, while time symbol offsets of {1, 2, 5, 6, 8, 9, 12 and 13} may be applied to the HAP 1410B. The UE 1410, which is exactly at the center of the two HAPs, would see this timing offset and thus pilot interference would be fully mitigated. Since RF signals travel at the speed of light, every 300 m corresponds to a 1 μs difference in time-of-flight. For a city with a 5 km radius, the total time offset between the edge of the city and the center of the city would be approximately 17 μs, which is sufficiently smaller than the symbol time of 70 μs that one would expect for this arrangement to be effective.

A service region (e.g., a country) may be quite large. Analysis may be performed based on the various cities in the service region to determine the PCI offset. It would be desirable to reduce the interference in regions with larger population densities than in regions with smaller population densities.

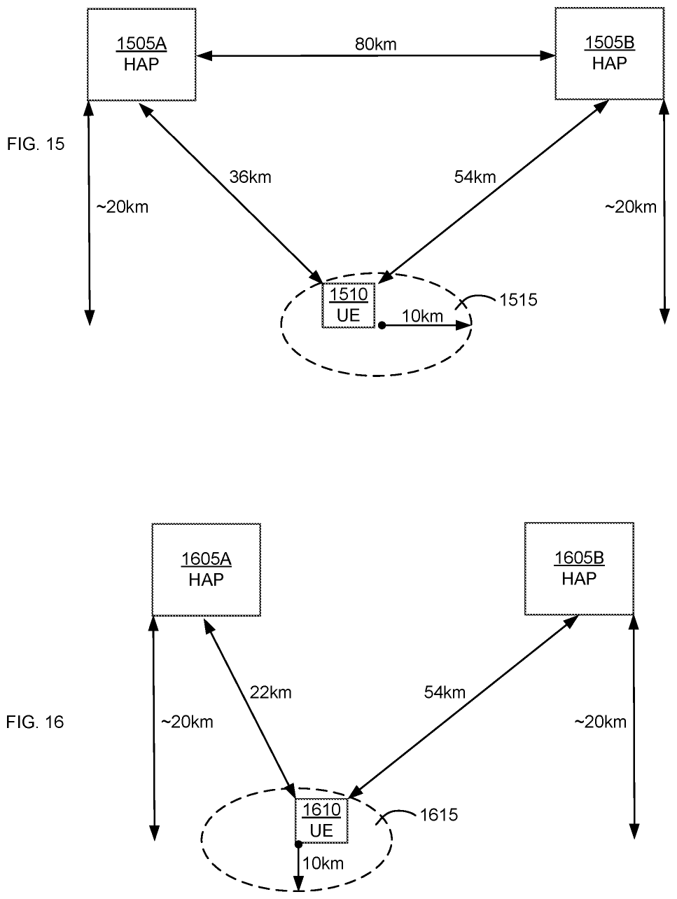

FIG. 15 shows another example where a populated region 1515 on the ground has a 10 km radius and the HAPs 1505A and 1505B are 80 km apart. In this case, the time delay between the UEs 1505A and 1505B experienced by the UE 1510 in the region 1515 is determined based on the difference between the distance between each HAP 1505 and the UE 1510 and dividing the result by 3e8 as follows: (54 km-36 km)/3e8=60 μs. This is almost 1 symbol. Thus, the only possible time symbol offsets that work out of {1, 2, 5, 6, 8, 9, 12 and 13} are {2 and 9} because only a one-symbol shift is necessary. These two time symbol offsets have a 1 symbol buffer on either side which allows for the 60 μs delay difference. Picking one of the time symbol offsets {2, 9} allows the region 1515 to be pilot contamination-free. Outside the region 1515, there is still a problem however, but in this case the signal strength from one of the HAPs 1505 will be much stronger than the signal strength from the HAP 1505.

FIG. 16 shows another example where a HAP 1605A is 22 km from a UE 1610 in a region 1615, and a HAP 1605B is 54 km from the UE 1610. HAP 1605A may use time symbol offset 0 and HAP 1605B may use time symbol offsets {0, 1, 3, 7, 8, 10}. In this case, time-of-flight differences cause the pilots not to interfere. There may be signal strength differences between the signal 1620A from the HAP 1605A and the signal 1620B from the HAP 1605B, because the UE 1610 is much closer to the HAP 1605A.

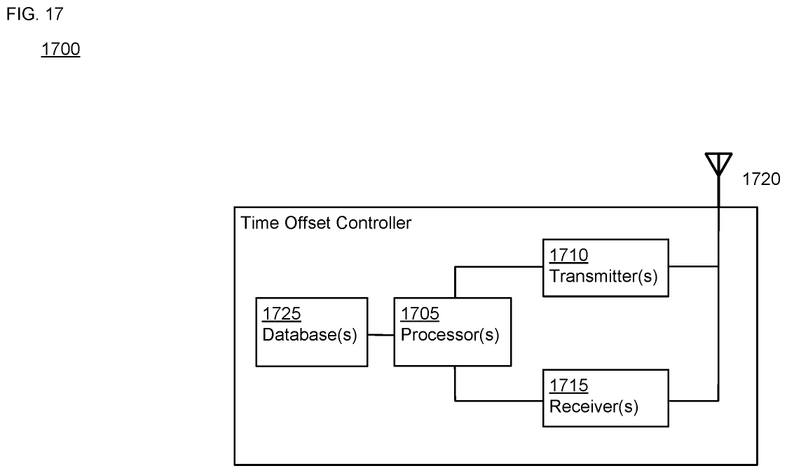

Thus, in the situation where it is desired for the entire region 1615 be pilot interference-free, differences in PCIs may be selected instead of just timing offsets. FIG. 17 illustrates a time offset controller 1700 in accordance with one aspect of the technology. The time offset controller 1700 may be located in a node, such as in one of a plurality of HAPs, or located on the ground inside or outside a region of interest. The time offset controller 1700 may include one or more processors 1705, one or more transmitters 1710, one or more receivers 1715, one or more antennas 1720 and one or more databases 1725. Based on information gathered by the time offset control system 1700 from the HAPs and/or the UE and stored in the one or more databases 1725, the time offset controller 1700 is configured to set the time symbol offsets of the HAPs. The time offset controller 1700 is configured to generate and transmit a command signal to each of the HAPs that indicates a time shift in pilot symbols transmitted in one sector to avoid colliding with other pilot symbols transmitted in a different sector. The time offset control system 1700 can be located on the ground or in a HAP. The time offset control system 1700 may maintain parameters across HAPs, determine the correct PCIs and timing offsets and communicate this information to the HAPs, which then implement the parameters.

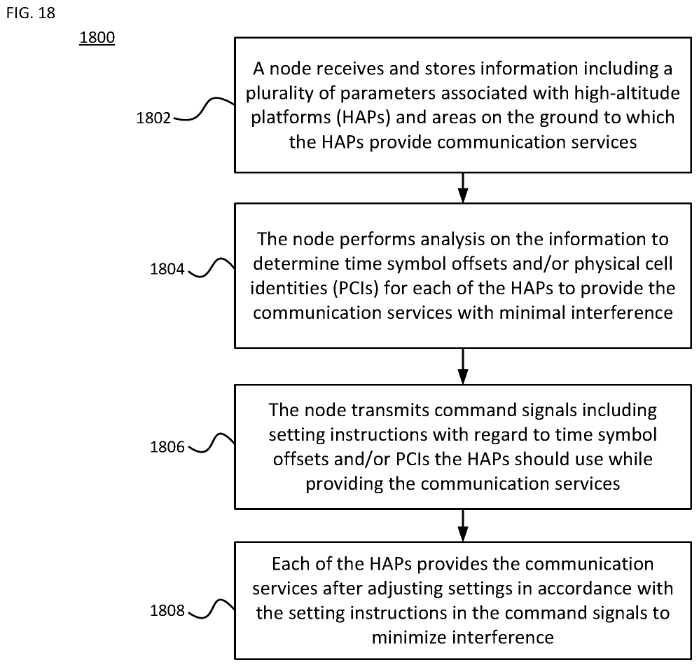

FIG. 18 shows a flow diagram of a method 1800 in accordance with aspects of the technology.

In block 1802 of FIG. 18, a node including the time offset control system 1700 receives and stores information including a plurality of parameters associated with high-altitude platforms (HAPs) and areas on the ground to which the HAPs provide communication services.

In block 1804 of FIG. 18, the node including the time offset control system 1700 performs analysis on the information to determine time symbol offsets and/or PCIs for each of the HAPs to provide the communication services with minimal interference.

In block 1806 of FIG. 18, the node including the time offset control system 1700 transmits command signals including setting instructions with regard to time symbol offsets and/or PCIs the HAPs should use while providing the communication services.

In block 1808, each of the HAPs provides the communication services after adjusting settings in accordance with the setting instructions in the command signals to minimize interference.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the aspects should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible aspects. Further, the same reference numbers in different drawings can identify the same or similar elements.

1. A node configured to minimize interference caused by a plurality of high-altitude platforms (HAPs) configured for operation in the stratosphere, the node comprising:
at least one transmitter configured to transmit setting instructions with regard to at least one of time symbol offsets and selected physical cell identities (PCIs) the HAPs should use to minimize interference while providing communication services;
at least one receiver configured to receive information including a plurality of parameters associated with the HAPs and areas on the ground to which the HAPs provide communication services;
a memory configured to store the information received by the at least one receiver; and
at least one processor coupled to the at least one transmitter, the at least one receiver and the memory, wherein the at least one processor is configured to: (1) retrieve the information from the memory, and (2) analyze the retrieved information to determine at least one of time symbol offsets and PCIs for each of the HAPs to provide the communication services with minimal interference.

2. The node of claim 1, wherein the setting instructions are provided to the HAPs to avoid pilot symbol collisions by changing timing between cell sectors.

3. The node of claim 2, wherein the HAPs shift pilot symbols in a time domain to avoid the pilot symbol collisions.

4. The node of claim 3, wherein the pilot symbols are shifted by 1 pilot symbol.

5. The node of claim 3, wherein the pilot symbols are shifted by 2 pilot symbols.

6. The node of claim 1, wherein the setting instructions are included in command signals that are based, in part, on an analysis of population densities performed by the at least one processor.

7. The node of claim 6, wherein the setting instructions are included in command signals that are further based on a location of each of the HAPs.

8. The node of claim 7, wherein the setting instructions are included in command signals that are further based on distances of the HAP locations from the population densities.

9. The node of claim 8, wherein the setting instructions are implemented by the HAPs to most aggressively reduce interference in one or more regions with the largest population densities.

10. The node of claim 1, wherein the setting instructions specify selected differences between PCIs to reduce or eliminate interference, wherein the selected differences are associated with a frequency offset, a timing offset, or a combination thereof.

11. A method for minimizing interference caused by a plurality of high-altitude platforms (HAPs) configured for operation in the stratosphere, the method comprising:
receiving, by at least one receiver, information including a plurality of parameters associated with the HAPs and areas on the ground to which HAPs provide communication services;
storing, by a memory, the information received by the at least one receiver;
retrieving, by at least one processor, the received information from the memory;
analyzing, by the at least one processor, the retrieved information to determine at least one of time symbol offsets and physical cell identities (PCIs) for each of the HAPs to provide the communication services with minimal interference; and
transmitting, by at least one transmitter, setting instructions with regard to at least one of time symbol offsets and selected PCIs the HAPs should use to minimize interference while providing communication services.

12. The method of claim 11, wherein the setting instructions are provided to the HAPs to avoid pilot symbol collisions by changing timing between cell sectors.

13. The method of claim 12, wherein the HAPs shift pilot symbols in a time domain to avoid the pilot symbol collisions.

14. The method of claim 13, wherein the pilot symbols are to be shifted by 1 pilot symbol.

15. The method of claim 13, wherein the pilot symbols are to be shifted by 2 pilot symbols.

16. The method of claim 11, wherein the setting instructions are included in command signals that are based, in part, on an analysis of population densities performed by the at least one processor.

17. The method of claim 16, wherein the setting instructions are included in command signals that are further based on a location of each of the HAPs.

18. The method of claim 17, wherein the setting instructions are included in command signals that are further based on distances of the HAP locations from the population densities.

19. The method of claim 18, wherein the setting instructions are implemented by the HAPs to most aggressively reduce interference in regions with the largest population densities.

20. The method of claim 11, wherein the setting instructions specify selected differences between PCIs to reduce or eliminate interference, wherein the selected differences are associated with a frequency offset, a timing offset, or a combination thereof.
